(19) United States
(12) Patent Application Publication
(10) Pub. No.: US 2023/0394492 A1
(43) Pub. Date: Dec. 7, 2023

(54) AI-BASED DEFECT DIAGNOSIS SYSTEM AND METHOD

(71) Applicant: Noodle Analytics, Inc., San Francisco, CA (US)

(72) Inventors: Gopal Datt JOSHI, Fremont, CA (US); Ajeet SINGH, Dublin, CA (US); Jeffrey Yale ALPERT, Oakland, CA (US); Naveen TEWARI, Karnataka (IN); Amar KUMAR, Bihar (IN); Abhijeet Ganesh KALPANDE, Maharashtra (IN); Ketan LANJEWAR, Maharashtra (IN); Dileep Kumar BOTCHA, Andhra Pradesh (IN)

(73) Assignee: Noodle Analytics, Inc., San Francisco, CA (US)

(21) Appl. No.: 17/830,513

(22) Filed: Jun. 2, 2022

(51) Int. Cl. G06Q 30/00; G05B 23/02

(52) U.S. Cl. CPC G06Q 30/018; G05B 23/024; G05B 23/0221; G05B 23/0235

(57) ABSTRACT

An artificial intelligence (AI)-based defect diagnosis system for automatic identification of one or more defect drivers in a manufacturing environment is presented. The diagnosis system includes an input data module, an input specifications module, a product selection module, a product grouping module, a defect driver identification module, and an output module. A related method is also presented.

### BACKGROUND

Embodiments of the present invention generally relate to systems and methods for defect diagnosis in a manufacturing system, and more particularly to AI-based automated systems and methods for defect diagnosis in a manufacturing system.

Process manufacturing is a production method that creates goods by combining raw materials using a formula or recipe. It is frequently used in industries that produce bulk quantities of goods such as food, beverage, chemicals, gasoline, metals, paints, resins, and pharmaceuticals. The production process often requires a thermal or chemical conversion, and thus a product created through process manufacturing cannot be disassembled into its constituent parts or cannot be converted back to the raw material.

Process manufacturing relies on the flow of sequential steps with the completion of one step leading to the start of the next step. The manufacturing process typically involves complex processing at each step which is controlled through a setup of a large number of production conditions (also called parameters) and measurement of these parameters during production. The quality of the final product is a function of its raw material, recipe, and all the processing conditions across different steps the product has gone through during its production. Any variations in the production conditions, raw material, and/or recipe can impact the quality of a product.

Product quality refers to how well a product satisfies customer needs, serves its purpose, and meets industry standards. Product quality can be evaluated on several factors such as appearance, shape, size, dimensions, taste, color, and chemical, mechanical, electrical, or other properties. A product is classified as defective if it doesn't meet its specifications for any of its quality properties.

Product quality is evaluated at intermediate steps during production, if possible, and at the end of the production during final inspection before the product is shipped to the customer. If the product is found to be defective, it incurs a significant economic loss to the manufacturer in the form of scrap, additional re-work cost, material loss, yield loss, and human capital loss.

While quality operations have improved considerably with the adoption of traditional and advanced solutions (Statistical Process Control, Six Sigma, Quality Management Systems, etc.), these solutions continue to remain ineffective in terms of implementation time and the outcome, due to their inability to effectively identify the underlying higher-order defect causes in a large/complex production system. Thus, there is a need for automated systems and methods for defect diagnosis in manufacturing systems.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, an artificial intelligence (AI)-based defect diagnosis system for automatic identification of one or more defect drivers in a manufacturing system is presented. The diagnosis system includes an input data module configured to receive process data corresponding to one or more manufacturing processes and defect information corresponding to a plurality of products from a manufacturing system configured to produce the plurality of products using the one or more manufacturing processes. The system includes an input specifications module configured to receive product specifications from an operator for selecting a set of products from the plurality of products. The system includes a product selection module configured to select a set of defective products and a set of non-defective products from the plurality of products based on the product specifications. The system includes a product grouping module configured to divide the selected set of products into a plurality of product groups, wherein each product group of the plurality of product groups comprises a plurality of defective products and a plurality of non-defective products. The system includes a defect driver identification module configured to identify, using an AI model, one or more defect drivers for each product group of the plurality of product groups by comparing the plurality of defective products and the plurality of non-defective products in each group. The system includes an output module configured to generate an output comprising the identified one or more drivers for each product group of the plurality of product groups.

Briefly, according to an example embodiment, an artificial intelligence (AI)-based defect diagnosis system for automatic identification of one or more defect drivers in a manufacturing system is presented. The system includes a memory having computer-readable instructions stored therein. The system further includes a processor configured to execute the computer-readable instructions to: access a manufacturing system configured to produce a plurality of products using one or more manufacturing processes; receive process data corresponding to the one or more manufacturing processes and defect information corresponding to the plurality of products; receive product specifications from a user for selecting a set of products from the plurality of products; select a set of defective products and a set of non defective products from the plurality of products based on the product specifications; divide the selected set of products into a plurality of product groups, wherein each product group of the plurality of product groups comprises a plurality of defective products and a plurality of non-defective products; identify, using an AI model, one or more defect drivers for each product group of the plurality of product groups by comparing the plurality of defective products and the plurality of non-defective products in each group; and generate an output comprising the identified one or more drivers for each product group of the plurality of product groups.

According to another example embodiment, a method for artificial intelligence (AI)-based automatic identification of one or more defect drivers in a manufacturing system is presented. The method includes accessing a manufacturing system configured to produce a plurality of products using one or more manufacturing processes; receiving process data corresponding to the one or more manufacturing processes and defect information corresponding to the plurality of products; receiving product specifications from a user for selecting a set of products from the plurality of products; selecting based on the product specifications a set of defective products and a set of non defective products from the plurality of products; dividing the selected set of products into a plurality of product groups, wherein each product group of the plurality of product groups comprises a plurality of defective products and a plurality of non-defective products; identifying, using an AI model, one or more defect drivers for each product group of the plurality of product groups by comparing the plurality of defective products and the plurality of non-defective products in each group; and generating an output comprising the identified one or more drivers for each product group of the plurality of product groups.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example AI-based defect diagnosis system, according to some aspects of the present description,

FIG. 2 is a block diagram illustrating an example workflow to receive process data and defect information, according to some aspects of the present description,

FIG. 3 is a block diagram illustrating an example workflow for selecting a set of defective products and a set of non-defective products based on the product specifications, according to some aspects of the present description,

FIG. 4 is a block diagram illustrating an example workflow for dividing the selected set of products into a plurality of product groups based on different operating regimes for each product group of the plurality of product groups, according to some aspects of the present description,

FIG. 5 is a block diagram illustrating an example workflow for identifying one or more defect drivers for each product group of the plurality of product groups and generating an output based on the one more identified defect driver, according to some aspects of the present description,

FIG. 6 is a block diagram illustrating an example workflow for recommending one or more process changes based on a review of the output by one or more operators, according to some aspects of the present description,

FIG. 7 is a flow chart illustrating an example AI-based defect diagnosis method, according to some aspects of the present description, and

FIG. 8 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide systems and methods for artificial intelligence (AI)-based automatic identification of one or more defect drivers in a manufacturing system. The term “manufacturing system” as used herein refers to an entire manufacturing plant or one or more manufacturing sites (e.g., one or more production sites) within a manufacturing plant. The systems and methods as described herein are applicable to all manufacturing industries. Non-limiting examples of manufacturing industries include oil and gas industries, specialty chemicals industries (such as paints, coatings, resins, and the like), commodity chemicals industries (such as food, beverage, cosmetics, and the like), pharmaceutical industries, metal and alloy industries, and the like.

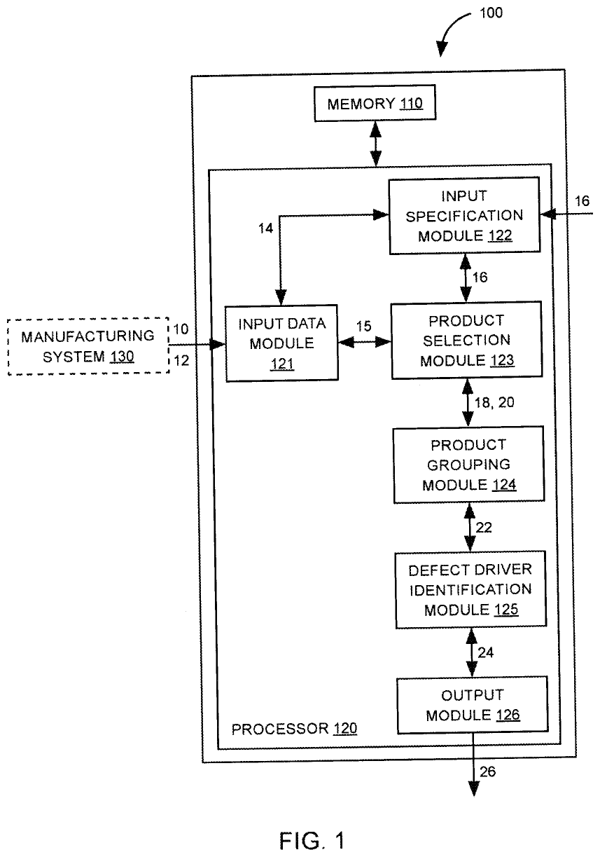

FIG. 1 illustrates an example Artificial Intelligence (AI)-based defect diagnosis system 100 (hereinafter referred to as simply “diagnosis system 100”), in accordance with some embodiments of the present description. The diagnosis system 100 is operatively coupled to a manufacturing system 130 as shown in FIG. 1. The diagnosis system 100 may operationalize in multiple ways for the manufacturing system 130 such as via a web/cloud application or as a stand-alone application within the manufacturing system 130. The diagnosis system 100 may be configured to diagnose a product-specific defect, a defect type across manufacturing time durations, or a combination thereof.

The diagnosis system 100 includes a memory 110 having computer-readable instructions stored therein. The diagnosis system 100 further includes a processor 110 operatively coupled to the memory 110. The processor 110 includes an input data module 121, an input specification module 122, a product selection module 123, a product grouping module 124, a defect driver identification module 125, and an output module 126. Each of these components is described in detail below.

As noted earlier, the manufacturing system 130 is configured to produce a plurality of products using one or more manufacturing processes. The input data module 121 is configured to receive process data 10 corresponding to the one or more manufacturing processes and defect information 12 corresponding to the plurality of products from the manufacturing system 130.

Non-limiting examples of process data 10 include historical process parameters, real-time process parameters, raw materials mix data before and after production, process metadata, or combinations thereof. The process parameters may be measured using sensors such as physical Internet of Things (IoT) sensors during production. The raw material mix data may be available via measurements taken before and after production.

In some embodiments, the input data module 121 is configured to initially receive historical process data e.g., all the historical process parameters from the manufacturing system 130. The input data module 121 may be communicatively coupled with a system database associated with the manufacturing system 130 and configured to receive the historical process parameters from the system database. The input data module 121 is further configured to receive process parameters (such as sensor data) from the manufacturing system 130 in real-time or incrementally (at predefined intervals).

Non-limiting examples of defect information 12 include defect measurement data, product disposition data, defect log data, quality inspection data, or combinations thereof. In some embodiments, the defect information 12 may be recorded and stored in the system database and the input data module 121 may be configured to access the system database at predefined intervals to receive the defect information.

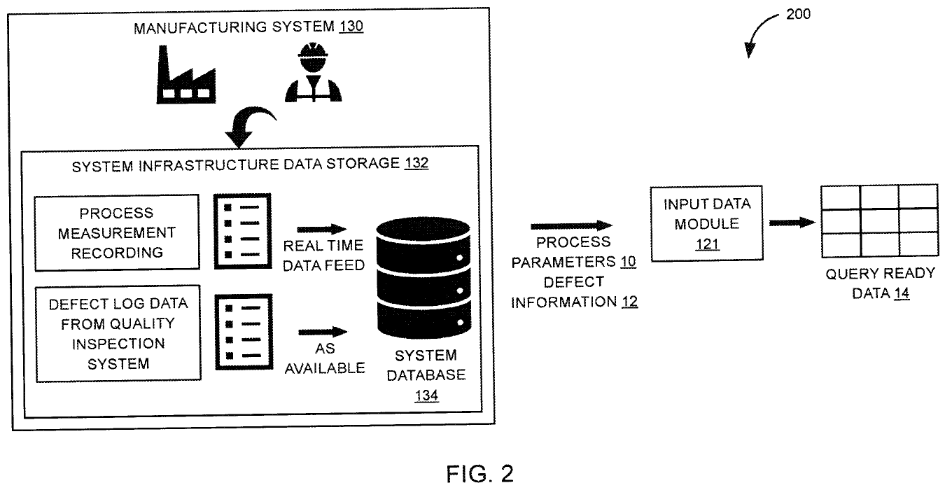

The input data module 121 may be further configured to process and analyze the process data 10 and the defect information 12 to prepare the data in a query-ready format. FIG. 2 illustrates an example workflow 200 wherein the input data module 121 is configured to receive process data 10 and defect information 12 and prepare the received data in a query-ready format 14. In the embodiment illustrated in FIG. 2 the process parameters 10 and the defect information 12 may be stored in a system database 134 of a system infrastructure data storage 132 operatively coupled to the manufacturing system 130.

Referring again to FIG. 1, the diagnosis system 100 further includes an input specification module 122 configured to receive product specifications 16 from a user for selecting a set of products from the plurality of products. Non-limiting examples of product specifications include product type, product dimensions, defect type, the time duration in which defects were observed, process parameters, or combinations thereof. The input specification module 122 may be configured to allow the user to select product specifications 16 from the query-ready data 14 prepared by the input module 121. In some embodiments, the input specification module 122 may be further configured to allow the user to select a defect diagnosis configuration. For example, the user may decide to run the defect diagnosis only for a few components within the manufacturing system 130 or a set of process parameters.

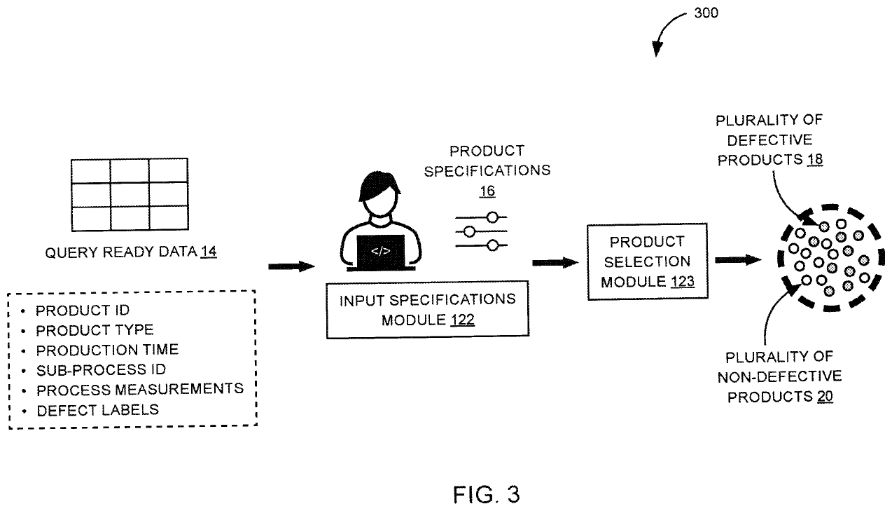

The diagnosis system 100 further includes a product selection module 123 configured to select, based on the product specifications 16, a set of defective products 18, and a set of non-defective products 20 from the plurality of products produced by the manufacturing system 130 using one or more manufacturing processes. The product selection module 123 is configured to query the plurality of products based on the product specifications 16 and select a set of defective products 18. The product selection module 123 is further configured to query the plurality of products based on the product specifications 16 and select a set of non-defective products 20. FIG. 3 illustrates an example workflow 300 for selecting the set of defective products 18 and the set of non-defective products 20 based on the product specifications 16.

Referring again to FIG. 1, the diagnosis system 100 further includes a product grouping module 124 configured to divide the selected set of products 18, 20 into a plurality of product groups 22, wherein each product group of the plurality of product groups 22 comprises a plurality of defective products and a plurality of non-defective products.

The product grouping module 124 may be configured to divide the selected set of products 18, 20 into the plurality of product groups 22 based on different operating regimes for each product group of the plurality of product groups 22. The term “operating regime” as used herein refers to an underlying set of process conditions used to generate each product group of the plurality of product groups. Thus, an operating regime for each product group of the plurality of product groups is different, and each operating regime is characterized by a set of process parameters.

In some embodiments, the product grouping module 124 is configured to divide the plurality of products into the plurality of product groups 22 based on operating ranges of a plurality of process parameters. Dividing the selected set of products based on operating regime allows for accurately identifying the underlying cause for defects for each product group, as the underlying cause may vary between the product groups.

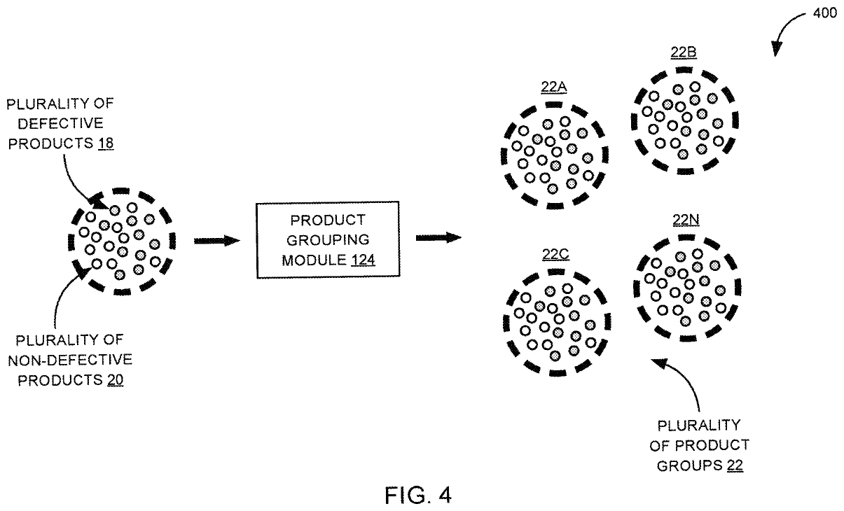

FIG. 4 illustrates an example workflow 400 for dividing the selected set of products 18, 20 into the plurality of product groups 22 based on different operating regimes for each product group of the plurality of product groups 22. As shown in FIG. 4 the plurality of product groups 22 includes product groups 22A, 22B, 22C . . . 22N, wherein each product group includes a plurality of defective products and a plurality of non-defective products.

Referring again to FIG. 1, the diagnosis system 100 further includes a defect driver identification module 125 configured to identify, using an AI model, one or more defect drivers 24 for each product group of the plurality of product groups 22 by comparing the plurality of defective products and the plurality of non-defective products in each group. Non-limiting examples of suitable AI models include decision tree, random tree, and the like

The term “defect driver” as used herein refers to a condition applicable for one or more processes that if satisfied can potentially lead to a defective product. Similarly, if the condition is not satisfied then it can lead to a defect-free product. The defect driver identification module 125 may be further configured to generate a plurality of defect drivers for each product group and identify a primary defect driver along with one or more alternate defect drivers.

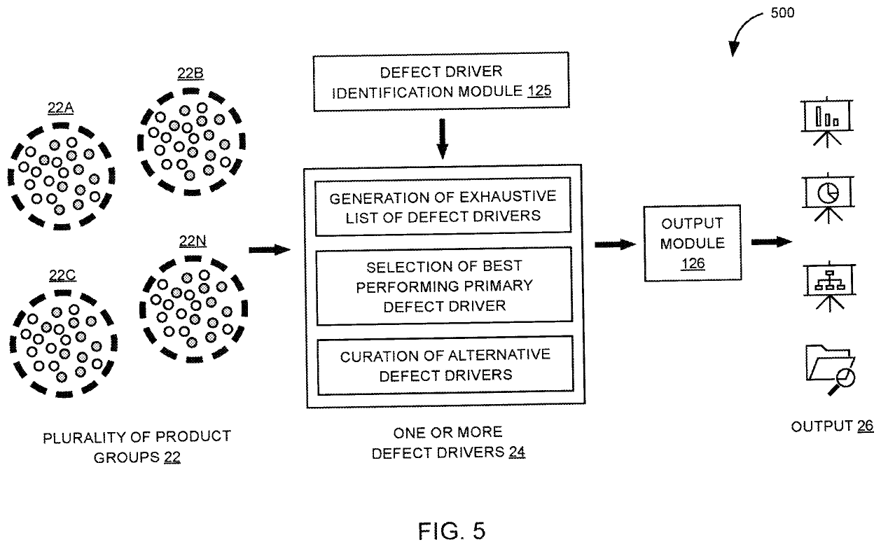

The diagnosis system 100 further includes an output module 126 configured to generate an output 26 including the identified one or more drivers 24 for each product group of the plurality of product groups 22. Non-limiting examples of the output 26 include univariate charts, bivariate charts, rule definition plots, or combinations thereof. FIG. 5 illustrates an example workflow 500 for identifying one or more defect drivers 24 for each product group of the plurality of product groups 22 and generating an output 26 based on the one more identified defect drivers.

In some embodiments, the defect driver identification module 125 may be configured to identify one or more differences between the plurality of defective products and the plurality of non-defective products within each group of the plurality of product groups 22. The defect driver identification module 125 may be further configured to generate one or more rule definitions to define multi-dimensional zones having a maximum occurrence of the defects based on the one or more differences identified. In some embodiments, the defect driver identification module 125 is configured to maximize Matthew's correlation coefficient when generating one or more rule definitions. In such embodiments, the output module 126 is configured to generate the output 26 comprising the identified one or more drivers 24 based on the defined multi-dimensional zones.

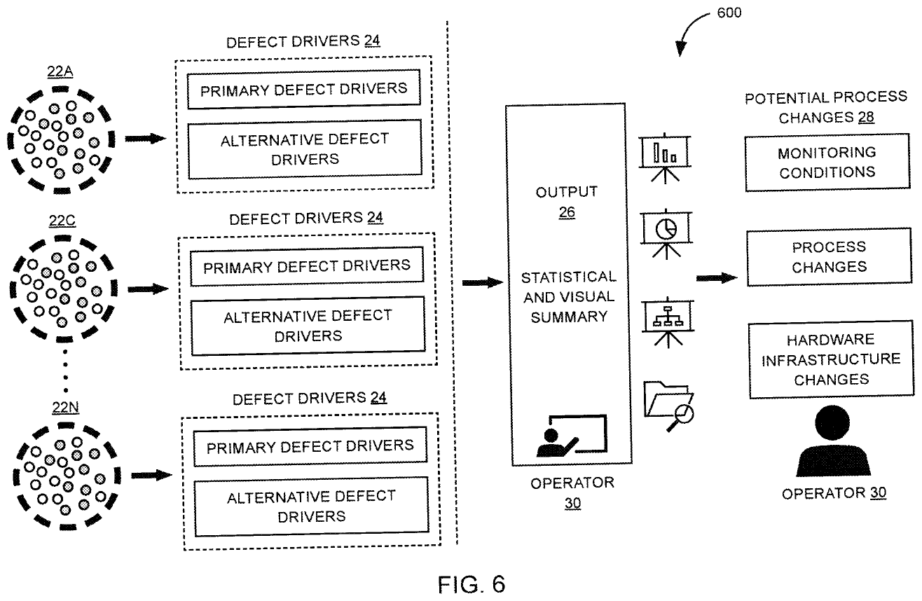

The output 26 may be reviewed by one or more operators in the manufacturing system 130 and based on the review one or more changes may be implemented in the manufacturing system 130 to avoid similar defects in future manufacturing processes. In some embodiments, the manufacturing system 130 may be further configured to implement process changes in the manufacturing system 130, implement hardware infrastructure changes in the manufacturing system 130, or monitor process conditions in the manufacturing system 130, based on a review of the output 26 by the one or more operators. FIG. 6 illustrates a workflow 600 for recommending one or more process changes 28 based on a review of the output 26 by one or more operators 30.

In some embodiments, the diagnosis system 100 may be further configured to generate recommendations to reduce a defect rate based on whether the process parameters related to the defects are controllable or non-controllable. By way of example, for controllable process parameters, the diagnosis system 100 may recommend one or more setpoints for the identified defect drivers 24 such that future manufacturing processes follow the recommended setpoints. For non-controllable parameters, the diagnosis system 100 may recommend constant monitoring of the identified defect drivers to ensure that their ranges don't deviate too much from the recommendation.

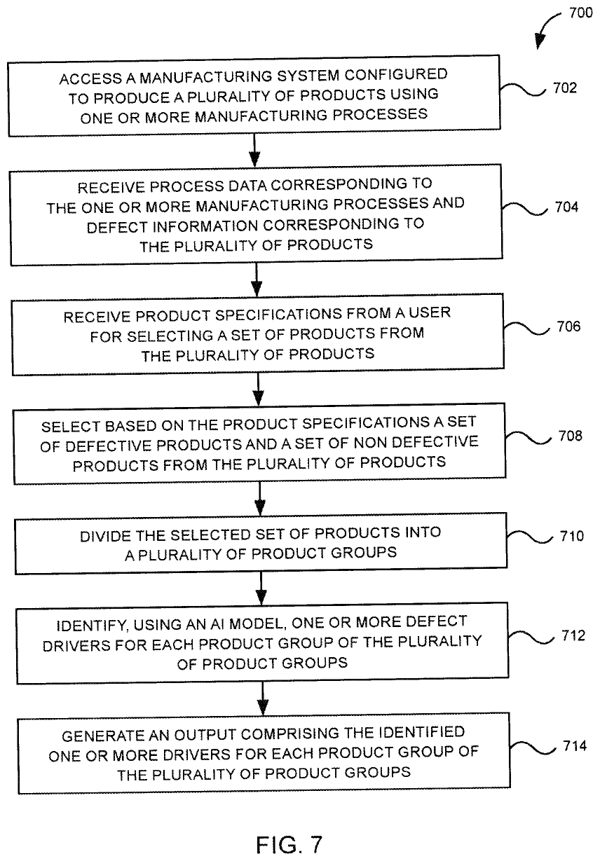

Referring again to FIG. 1, a diagnosis system 100 for artificial intelligence (AI)-based automatic identification of one or more defect drivers in a manufacturing system 130 is presented. The diagnosis system 100 includes a memory 110 storing one or more processor-executable routines, and a processor 120. The processor 120 is configured to execute the processor-executable routines to perform the steps illustrated in the flowchart of FIG. 7.

FIG. 7 is a flowchart illustrating a method 700 for artificial intelligence (AI)-based automatic identification of one or more defect drivers in a manufacturing system. The method 700 includes diagnosing a product-specific defect, a defect type across manufacturing time durations, or a combination thereof. The method 700 may be implemented using defect diagnosis system 100 of FIG. 1 according to some aspects of the present description. Each step of the method 700 is described in detail below.

The method 700 includes, at step 702 accessing a manufacturing system configured to produce a plurality of products using one or more manufacturing processes. The method 700 further includes, at step 704, receiving process data corresponding to the one or more manufacturing processes and defect information corresponding to the plurality of products. Step 704 may further include processing and analyzing the process data and the defect information to prepare the data in a query-ready format.

Non-limiting examples of process data include historical process parameters, real-time process parameters, raw materials mix data before and after production, process metadata, or combinations thereof. The process parameters may be measured using sensors such as physical Internet of Things (IoT) sensors during production. The raw material mix data may be available via measurements taken before and after production.

Non-limiting examples of defect information include defect measurement data, product disposition data, defect log data, quality inspection data, or combinations thereof. In some embodiments, the defect information may be recorded and stored in the system database and step 704 may include accessing the system database at predefined intervals to receive the defect information.

At step 706, the method 700 includes receiving product specifications from a user for selecting a set of products from the plurality of products. Non-limiting examples of product specifications include product type, product dimensions, defect type, time duration in which defects were observed, process parameters, or combinations thereof. In some embodiments, step 706 may further include allowing the user to select a defect diagnosis configuration.

The method 700 further includes, at step 708, selecting based on the product specifications a set of defective products and a set of non-defective products from the plurality of products. In some embodiments, step 708 includes querying the plurality of products based on the product specifications and selecting a set of defective products and a set of non-defective products.

At step 710, the method 700 includes dividing the selected set of products into a plurality of product groups, wherein each product group of the plurality of product groups comprises a plurality of defective products and a plurality of non-defective products. In some embodiments, step 710 includes dividing the selected set of products into the plurality of product groups based on different operating regimes for each product group of the plurality of product groups, wherein each operating regime is characterized by a set of process parameters. The term “operating regime” as used herein refers to an underlying set of process conditions used to generate each product group of the plurality of product groups.

The method 700 further includes, at step 712, identifying, using an AI model, one or more defect drivers for each product group of the plurality of product groups by comparing the plurality of defective products and the plurality of non-defective products in each group. Non-limiting examples of suitable AI models include decision tree, random tree, and the like. At step 714, the method 700 includes generating an output based on the identified defect drivers. Non-limiting examples of the output include univariate charts, bivariate charts, rule definition plots, or combinations thereof.

In some embodiments, the method 700 includes, at step 710, dividing the plurality of products into the plurality of product groups based on operating ranges of a plurality of process parameters. Step 710 for generating the plurality of product groups may include shortlisting process parameters which are highly correlated with the target variable. Step 710 may further include identifying two process parameters that in interaction with the target variable can maximize the Matthew's correlation coefficient. Further step 710 may include dividing a two-dimensional (2D) process parameter space into zones such that the separation within each zone is maximized. Each zone may be characterized by an equation that defines the boundaries of the zone

The method 700 further includes, at step 712, identifying one or more differences between the plurality of defective products and the plurality of non-defective products within each group of the plurality of product groups. The method 700 further includes, at step 712, generating one or more rule definitions to define multi-dimensional zones having maximum occurrence of the defects based on the one or more differences identified. Step 712 may further include maximizing Matthew's correlation coefficient when generating the one or more rule definitions. At step 714, the method 700 further includes generating the output comprising the identified one or more drivers based on the defined multi-dimensional zones.

The output may be reviewed by one or more operators in the manufacturing system and based on the review one or more changes may be implemented in the manufacturing system to avoid similar defects in future manufacturing processes. In some embodiments, the method 700 may further include implementing process changes in the manufacturing system, implementing hardware infrastructure changes in the manufacturing system, or monitoring process conditions in the manufacturing system, based on the review of the output by an operator.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor, or any device which may execute instructions and respond. A central processing unit may implement an operating system (OS) or one or more software applications running on the OS. Further, the processing unit may access, store, manipulate, process and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

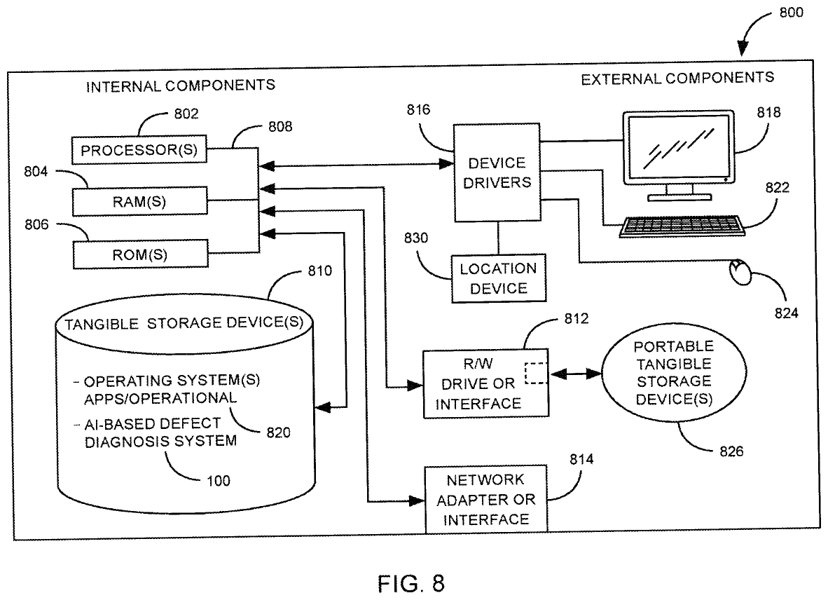

One example of a computing system 800 is described below in FIG. 8. The computing system 800 includes one or more processor 802, one or more computer-readable RAMs 804, and one or more computer-readable ROMs 808 on one or more buses 808. Further, the computer system 808 includes a tangible storage device 810 that may be used to execute operating systems 820 and defect diagnosis system 100. Both, the operating system 820 and the defect diagnosis system 100 are executed by processor 802 via one or more respective RAMs 804 (which typically includes cache memory). The execution of the operating system 820 and/or the defect diagnosis system 100 by the processor 802, configures the processor 802 as a special-purpose processor configured to carry out the functionalities of the operation system 820 and/or the defect diagnosis system 100, as described above.

Examples of storage devices 810 include semiconductor storage devices such as ROM 806, EPROM, flash memory, or any other computer-readable tangible storage device that may store a computer program and digital information.

Computing system 800 also includes a R/W drive or interface 812 to read from and write to one or more portable computer-readable tangible storage devices 826 such as a CD-ROM, DVD, memory stick or semiconductor storage device. Further, network adapters or interfaces 814 such as a TCP/IP adapter cards, wireless Wi-Fi interface cards, or 3G or 4G wireless interface cards or other wired or wireless communication links are also included in the computing system 800.

In one example embodiment, the defect diagnosis system 100 may be stored in tangible storage device 810 and may be downloaded from an external computer via a network (for example, the Internet, a local area network or another wide area network) and network adapter or interface 814.

Computing system 800 further includes device drivers 816 to interface with input and output devices. The input and output devices may include a computer display monitor 818, a keyboard 822, a keypad, a touch screen, a computer mouse 824, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. An artificial intelligence (AI)-based defect diagnosis system for automatic identification of one or more defect drivers in a manufacturing system, comprising:
an input data module configured to receive process data corresponding to one or more manufacturing processes and defect information corresponding to a plurality of products from a manufacturing system configured to produce the plurality of products using the one or more manufacturing processes;
an input specifications module configured to receive product specifications from an operator for selecting a set of products from the plurality of products;
a product selection module configured to select based on the product specifications a set of defective products and a set of non-defective products from the plurality of products;
a product grouping module configured to divide the selected set of products into a plurality of product groups, wherein each product group of the plurality of product groups comprises a plurality of defective products and a plurality of non-defective products;
a defect driver identification module configured to identify, using an AI model, one or more defect drivers for each product group of the plurality of product groups by comparing the plurality of defective products and the plurality of non-defective products in each group; and
an output module configured to generate an output comprising the identified one or more drivers for each product group of the plurality of product groups.

2. The AI-based defect diagnosis system of claim 1, wherein the product grouping module is configured to divide the selected set of products into the plurality of product groups based on different operating regimes for each product group of the plurality of product groups, wherein each operating regime is characterized by a set of process parameters.

3. The AI-based defect diagnosis system of claim 1, wherein
the product grouping module is configured to divide the plurality of products into the plurality of product groups based on operating ranges of a plurality of process parameters;
the defect driver identification module is configured to identify one or more differences between the plurality of defective products and the plurality of non-defective products within each group of the plurality of product groups, and generate one or more rule definitions to define multi-dimensional zones having a maximum occurrence of the defects based on the one or more differences identified; and
the output module is configured to generate the output comprising the identified one or more drivers based on the defined multi-dimensional zones.

4. The AI-based defect diagnosis system of claim 3, wherein the defect driver identification module is configured to maximize Matthew's correlation coefficient when generating the one or more rule definitions.

5. The AI-based defect diagnosis system of claim 1, wherein the process data comprises historical process parameters, real-time process parameters, raw materials mix data before production, and process metadata, and to receive defect information comprising defect measurements, product disposition data, defect log data and quality inspection data.

6. The AI-based defect diagnosis system of claim 1, wherein the product specifications comprise product type, product dimensions, defect type, time duration in which defects were observed, process parameters, or combinations thereof.

7. The AI-based defect diagnosis system of claim 1, wherein the output comprises one or more univariate charts, bivariate charts, rule definition plots, or combinations thereof.

8. The AI-based defect diagnosis system of claim 1, wherein the system is further configured to recommend process changes in the manufacturing system, implement hardware infrastructure changes in the manufacturing system, or monitor process conditions in the manufacturing system, based on a review of the output by one or more operators.

9. The AI-based defect diagnosis system of claim 1, wherein the system is configured to diagnose a product-specific defect, a defect type across manufacturing time durations, or a combination thereof.

10. An artificial intelligence (AI)-based defect diagnosis system for automatic identification of one or more defect drivers in a manufacturing system, comprising:
a memory having computer-readable instructions stored therein;
a processor configured to execute the computer-readable instructions to:
access a manufacturing system configured to produce a plurality of products using one or more manufacturing processes;
receive process data corresponding to the one or more manufacturing processes and defect information corresponding to the plurality of products;
receive product specifications from a user for selecting a set of products from the plurality of products;
select based on the product specifications a set of defective products and a set of non-defective products from the plurality of products;
divide the selected set of products into a plurality of product groups, wherein each product group of the plurality of product groups comprises a plurality of defective products and a plurality of non-defective products;
identify, using an AI model, one or more defect drivers for each product group of the plurality of product groups by comparing the plurality of defective products and the plurality of non-defective products in each group; and
generate an output comprising the identified one or more drivers for each product group of the plurality of product groups.

11. The AI-based defect diagnosis system of claim 10, wherein the processor is configured to execute the computer-readable instructions to divide the selected set of products into the plurality of product groups based on different operating regimes for each product group of the plurality of product groups, wherein each operating regime is characterized by a set of process parameters.

12. The AI-based defect diagnosis system of claim 10, wherein the processor is further configured to execute the computer-readable instructions to:
divide the plurality of products into the plurality of product groups based on operating ranges of a plurality of process parameters;
identify one or more differences between the plurality of defective products and the plurality of non-defective products within each group of the plurality of product groups;
generate one or more rule definitions to define multi-dimensional zones having a maximum occurrence of the defects based on the one or more differences identified; and
generate the output comprising the identified one or more drivers based on the defined multi-dimensional zones.

13. The AI-based defect diagnosis system of claim 12, wherein the processor is configured to execute the computer-readable instructions to maximize Matthew's correlation coefficient when generating the one or more rule definitions.

14. A method for artificial intelligence (AI)-based automatic identification of one or more defect drivers in a manufacturing system, comprising:
accessing a manufacturing system configured to produce a plurality of products using one or more manufacturing processes;
receiving process data corresponding to the one or more manufacturing processes and defect information corresponding to the plurality of products;
receiving product specifications from a user for selecting a set of products from the plurality of products;
selecting based on the product specifications a set of defective products and a set of non-defective products from the plurality of products;
dividing the selected set of products into a plurality of product groups, wherein each product group of the plurality of product groups comprises a plurality of defective products and a plurality of non-defective products;
identifying, using an AI model, one or more defect drivers for each product group of the plurality of product groups by comparing the plurality of defective products and the plurality of non-defective products in each group; and
generating an output comprising the identified one or more drivers for each product group of the plurality of product groups.

15. The method of claim 14, comprising dividing the selected set of products into the plurality of product groups based on different operating regimes for each product group of the plurality of product groups, wherein each operating regime is characterized by a set of process parameters.

16. The method of claim 14, comprising:
dividing the plurality of products into the plurality of product groups based on operating ranges of a plurality of process parameters;
identifying one or more differences between the plurality of defective products and the plurality of non-defective products within each group of the plurality of product groups;
generating one or more rule definitions to define multi-dimensional zones having a maximum occurrence of the defects based on the one or more differences identified; and
generating the output comprising the identified one or more drivers based on the defined multi-dimensional zones.

17. The method of claim 16, comprising maximizing Matthew's correlation coefficient when generating the one or more rule definitions.

18. The method of claim 14, wherein the product specifications comprise product type, product dimensions, defect type, time duration in which defects were observed, process parameters, or combinations thereof.

19. The method of claim 14, further comprising implementing process changes in the manufacturing system, implementing hardware infrastructure changes in the manufacturing system, or monitoring process conditions in the manufacturing system, based on a review of the output by an operator.

20. The method of claim 14, comprising diagnosing a product-specific defect, a defect type across manufacturing time durations, or a combination thereof.
